(19) United States
(12) Patent Application Publication
(10) Pub. No.: US 2007/0155478 A1
(43) Pub. Date: Jul. 5, 2007

(54) Gaming machine

(75) Inventors: Masatsugu Kobayashi, Tokyo (JP); Keika Yokoyama, Tokyo (JP)

Correspondence Address: ARENT FOX PLLC, Suite 400, 1050 Connecticut Avenue, N.W., Washington, DC, 20036-5339, US

(73) Assignee: ARUZE CORP.

(21) Appl. No.: 11/640,505

(22) Filed: Dec. 18, 2006

(30) Foreign Application Priority Data
Dec. 20, 2005 (JP) P2005-367046

(51) Int. Cl. A63F 13/00

(52) U.S. Cl. 463/20

(57) ABSTRACT

A gaming machine has a lower liquid crystal display and a CPU. The lower liquid crystal display includes therein variable display portions in which a plurality of symbols to be used in a game are variably displayed and effect display regions in which effect contents are displayed according to a game state. The CPU controls the variable display of symbols in the variable display portions and the effect contents in the effect display regions. The CPU displays one or more additional symbols to be used for a winning determination in the game, in one or more effect display regions and in the vicinity of one or more symbols displayed in one or more variable display portions.

### CROSS REFERENCE TO RELATED APPLICATION

This application claims benefit of priority under 35 U.S.C. § 119 to Japanese Patent Application No. 2005-367046, filed on Dec. 20, 2005, the entire contents of which are incorporated by reference herein.

### BACKGROUND OF THE INVENTION

1. Field of the Invention

The present invention relates to a gaming machine, more specifically a gaming machine suitable to a slot machine etc.

2. Description of the Related Art

There is a conventional gaming machine operable to carry out an effect in conjunction with movements of one or more characters and reels. The gaming machine is disclosed in Japanese Patent Laid-open Publication No. 2005-13353. In the gaming machine, a liquid crystal display is arranged at a front surface side of the reels. A player can have visual contact with the reels through a display window of the liquid crystal display. The gaming machine is operable to carry out the effect in conjunction with the movements of the one or more characters and the reels by variably displaying symbols on the reels and dynamically displaying the one or more characters associated with the symbols on the liquid crystal display.

A player, who is accustomed to a game executed in the gaming machine, however gets tired of looking at the effect on the liquid crystal display because a winning determination is executed by only using the symbols on the reels and is not related to the one or more characters on the liquid crystal display.

### SUMMARY OF THE INVENTION

It is an object of the present invention to provide a gaming machine operable to allow a player, who is accustomed to a game executed in the gaming machine, to execute the game without getting tired.

In order to achieve the object, the present invention provides a gaming machine comprising: a display that includes therein a symbol display region in which a plurality of symbols to be used in a game are variably displayed and an effect display region in which effect contents are displayed according to a game state; and a controller that controls the variable display of symbols in the symbols display region and the effect contents in the effect display region, wherein the controller displays one or more symbols to be used for a winning determination in the game, in the effect display region and in the vicinity of one or more symbols displayed in the symbol display region.

According to the present invention, a type of winning combinations in the game increases because one or more symbols to be used for the winning determination in the game are displayed in the effect display region and in the vicinity of one or more symbols displayed in the symbol display region. This increases player's sense of expectancy and attracts player's interest for the game.

### BRIEF DESCRIPTION OF THE DRAWINGS

FIG. 1 is a perspective view of a slot machine according to an exemplary embodiment of the present invention.

FIG. 2 is an explanatory diagram of nine valuable display portions of the slot machine according to the exemplary embodiment of the present invention.

FIG. 3 is an explanatory diagram of eight activated paylines of the slot machine according to the exemplary embodiment of the present invention.

FIG. 4 is a block diagram of a control system of the slot machine according to the exemplary embodiment of the present invention.

FIG. 5 is a block diagram of a liquid crystal driving circuit of the slot machine according to the exemplary embodiment of the present invention.

FIG. 6 is a diagram showing a symbol row to be variably displayed on the valuable display portions according to the exemplary embodiment of the present invention.

FIG. 7 is an explanatory diagram of a lottery table for symbols to be statically displayed on the valuable display portions according to the exemplary embodiment of the present invention.

FIG. 8 is an explanatory diagram of winning combinations and a payout table for each winning combination according to the exemplary embodiment of the present invention.

FIG. 9 is a flowchart of a main process of the slot machine according to the exemplary embodiment of the present invention.

FIG. 10 is a flowchart of a start reception process of the slot machine according to the exemplary embodiment of the present invention.

FIG. 11 is a flowchart of a lottery process of the slot machine according to the exemplary embodiment of the present invention.

FIG. 12 is an explanatory diagram of one table to be employed at a time of determining one or more symbols to be added in an additional symbol determination process of the lottery process according to the exemplary embodiment of the present invention.

FIG. 13 is an explanatory diagram of another table to be employed at the time of determining the one or more symbols to be added in the additional symbol determination process of the lottery process according to the exemplary embodiment of the present invention.

FIG. 14 is a flowchart of a base game process of the slot machine according to the exemplary embodiment of the present invention.

FIG. 15 is an example diagram of one screen display of a lower liquid crystal display at a time of carrying out the base game in the slot machine according to the exemplary embodiment of the present invention.

FIG. 16 is an example diagram of another screen display of the lower liquid crystal display at the time of carrying out the base game in the slot machine according to the exemplary embodiment of the present invention.

### DESCRIPTION OF THE PREFERRED EMBODIMENTS

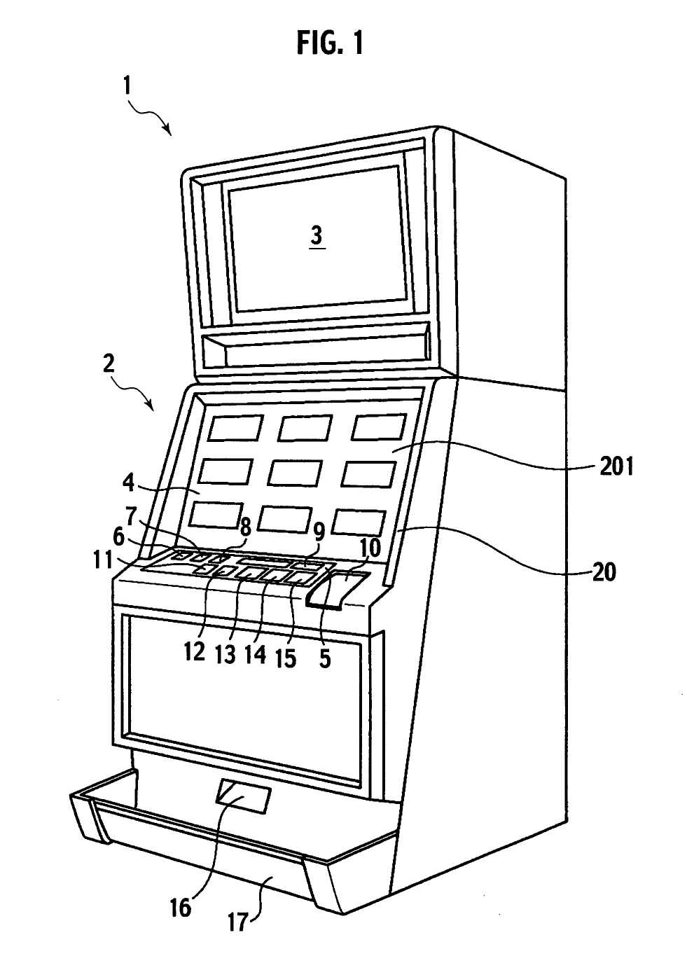

With reference to FIGS. 1 to 16, an exemplary embodiment of the present invention will be described below.

As shown in FIG. 1, a slot machine 1 comprises a cabinet 2, an upper liquid crystal display 3, a lower liquid crystal display 4, an operation table 5, a coin insertion portion 9, a bill insertion portion 10, a coin payout opening 16, a coin receiving portion 17, a front panel 20 and a transparent touch panel 201.

The cabinet 2 forms the entirety of the slot machine 1. The upper liquid crystal display 3 is mounted on a front upper portion of the cabinet 2. The lower liquid crystal display 4 is mounted within the front panel 20 on a front center portion of the cabinet 2. The upper liquid crystal display 3 and the lower liquid crystal display 4 are general liquid crystal displays. The transparent touch panel 201 is mounted on a front face of the lower liquid crystal display 4. The lower liquid crystal display 4 is employed as a display means.

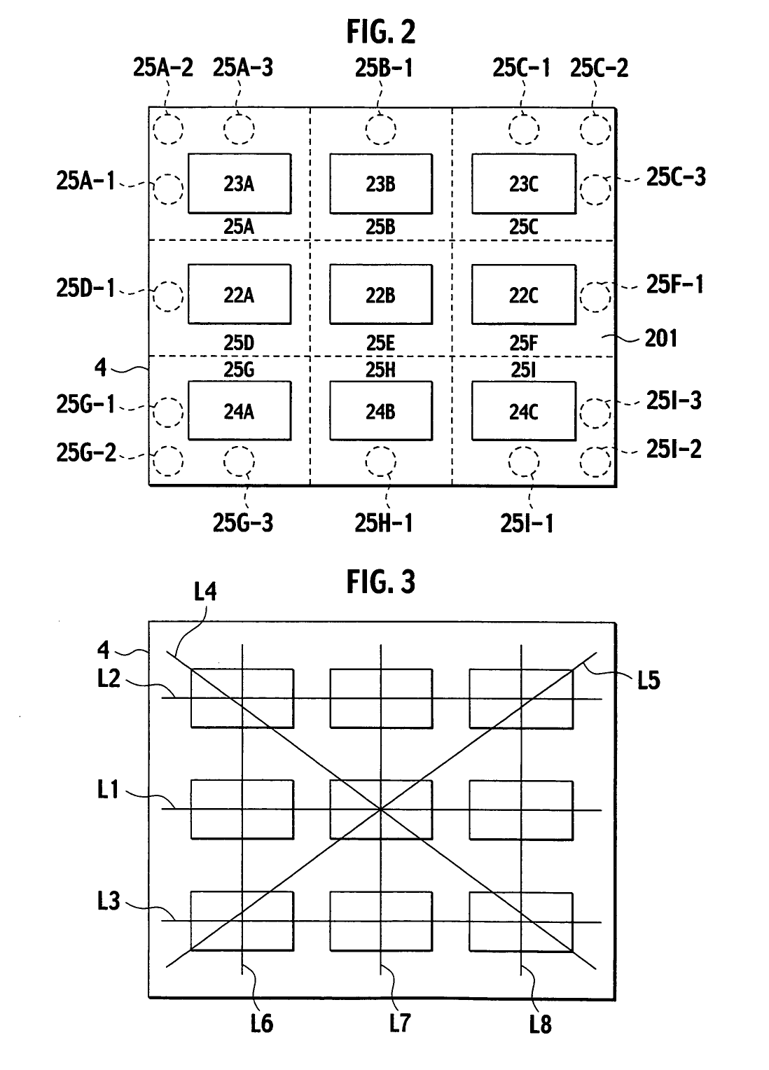

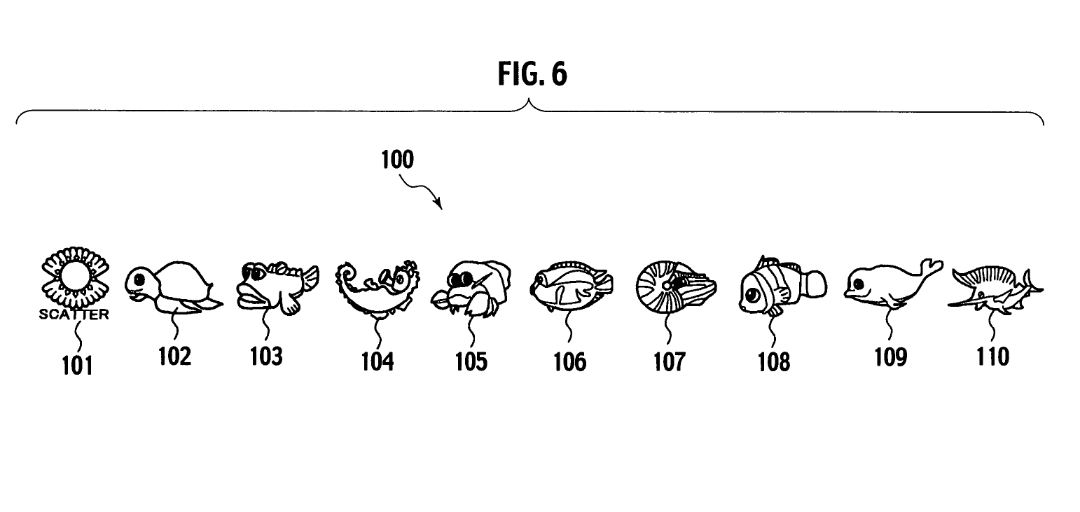

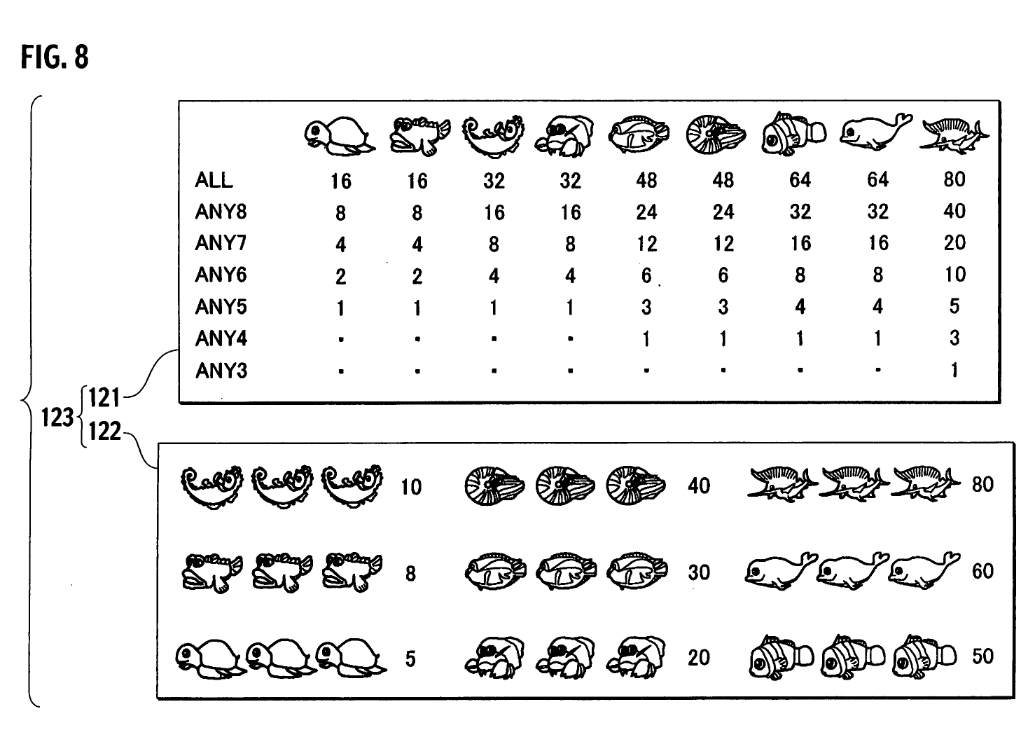

Plural pieces of information regarding a game, such as a game playing method, a payout table (see FIG. 8) in which types of winning combinations and payouts for the winning combinations are shown, and various effects for the game, are displayed on the upper liquid crystal display 3. Variable display portions 22A to 22C, 23A to 23C, 24A to 24C (see FIG. 2) corresponding to a symbol display region and activated paylines L1 to L8 (see FIG. 3) are displayed on the lower liquid crystal display 4. Various symbols shown in FIG. 6 are variably displayed on each variable display portion from the right to the left of each variable display portion while a video reel 100 rotates.

The lower liquid crystal display 4 has effect display regions 25A to 25I where images for creating the effects for the game are displayed. The effect display regions 25A to 25C are respectively arranged on positions corresponding to the variable display portions 23A to 23C. The effect display regions 25D to 25F are respectively arranged on positions corresponding to the variable display portions 22A to 22C. The effect display regions 25G to 25I are respectively arranged on positions corresponding to the variable display portions 24A to 24C. Background images and effect images are displayed on the effect display regions 25A to 25I. The background images are displayed independent of symbols variably displayed and symbols (game result) statically displayed on the variable display portions 22A to 22C, 23A to 23C, 24A to 24C. The effect images are also displayed independent of the symbols variably displayed and the symbols (game result) statically displayed on the variable display portions 22A to 22C, 23A to 23C, 24A to 24C, and slide past the symbols while the video reel 100 rotates. Normally, the effect images are displayed independent of a winning determination of the game. Further, additional symbols for determining whether or not the game is won are displayed on the effect display regions 25A to 25I. The additional symbols are additionally displayed in the vicinity of the variable display portions 22A to 22C, 23A to 23C, 24A to 24C (hereinafter called “additional display positions”).

More specifically, in the effect display region 25A, a part of the additional symbols is displayed on the additional display positions 25A-1, 25A-2, 25A-3 which are respectively arranged in the left side, the left above side, the above side of the variable display portion 23A. In the effect display region 25B, a part of the additional symbols is displayed on the additional display position 25B-1 which is arranged in the above side of the variable display portion 23B. In the effect display region 25C, apart of the additional symbols is displayed on the additional display positions 25C-1, 25C-2, 25C-3 which are respectively arranged in the above side, the right above side, the right side of the variable display portion 23C.

In the effect display region 25D, a part of the additional symbols is displayed on the additional display position 25D-1 which is arranged in the left side of the variable display portion 22A. In the effect display region 25F, a part of the additional symbols is displayed on the additional display position 25F-1 which is arranged in the right side of the variable display portion 22C. In the effect display region 25G, a part of the additional symbols is displayed on the additional display positions 25G-1, 25G-2, 25G-3 which are respectively arranged in the left side, the left below side, the below side of the variable display portion 24A. In the effect display region 25H, a part of the additional symbols is displayed on the additional display position 25H-1 which is arranged in the below side of the variable display portion 24B. In the effect display region 25I, a part of the additional symbols is displayed on the additional display positions 25I-1, 25I-2, 25I-3 which are respectively arranged in the below side, the right below side, the right side of the variable display portion 24C.

The operation table 5 is mounted below the lower liquid crystal display 4 and protrudes forward from the front center portion of the cabinet 2. A change button 6, a cashout button 7, a help button 8, the coin insertion portion 9, and the bill insertion portion 10 are arranged at the back of the operation table 5 in the order from the left side. A 1-BET button 11, a spin/repeat BET button 12, a 3-BET button 13, a 5-BET button 14, and an 8-BET button 15 are arranged at the front of the operation table 5 in the order from the left side.

The change button 6 is pushed when a player will change a bill inserted into the bill insertion portion 10. The cashout button 7 is pushed when the game is finished. If the cashout button 7 is pushed, one or more coins are paid out into the coin receiving portion 17 via the coin payout opening 16 as one or more game media obtained by a player at the game. The help button 8 is pushed, when a player does not know a playing method of the game etc. If the help button 8 is pushed, various pieces of help information are displayed on the upper liquid crystal display 3.

A coin sensor 65 is mounted in the coin insertion portion 9 and detects a coin inserted into the coin insertion portion 9. A bill sensor 66 is mounted in the bill insertion portion 10 and detects a bill inserted into the bill insertion portion 10. The 1-BET button 11 is pushed when a player bets one game medium on the game. One game medium is bet on the game every time the 1-BET button 11 is pushed. The spin/repeat BET button 12 is pushed when a player starts playing the game in a current bet number or previous bet number of game media. If the spin/repeat BET button 12 is pushed, the various symbols are variably displayed on the variable display portions 22A to 22C, 23A to 23C, 24 A to 24C. It is noted that the number of game media to be bet on the game is one, two, three, four, five or eight.

The 3-BET button 13 is pushed when a player bets three game media on the game. Three game media are bet on the game every time the 3-BET button 13 is pushed. The 5-BET button 14 is pushed when a player bets five game media on the game. Five game media are bet on the game every time the 5-BET button 14 is pushed. The 8-BET button 15 is pushed when a player bets eight game media on the game. Eight game media are bet on the game every time the 8-BET button 15 is pushed. The coin payout opening 16 is mounted on a lower portion of the cabinet 2. The coin receiving portion 17 is mounted on the lower portion of the cabinet 2 to receive one or more coins paid out from the coin payout opening 16.

In a case where the bet number is one, the number of activated paylines L1 to L8 is one. In a case where the bet number is two, the number of activated paylines L1 to L8 is two. In a case where the bet number is three, the number of activated paylines L1 to L8 is three. In a case where the bet number is five, the number of activated paylines L1 to L8 is five. In a case where the bet number is eight, the number of activated paylines L1 to L8 is eight.

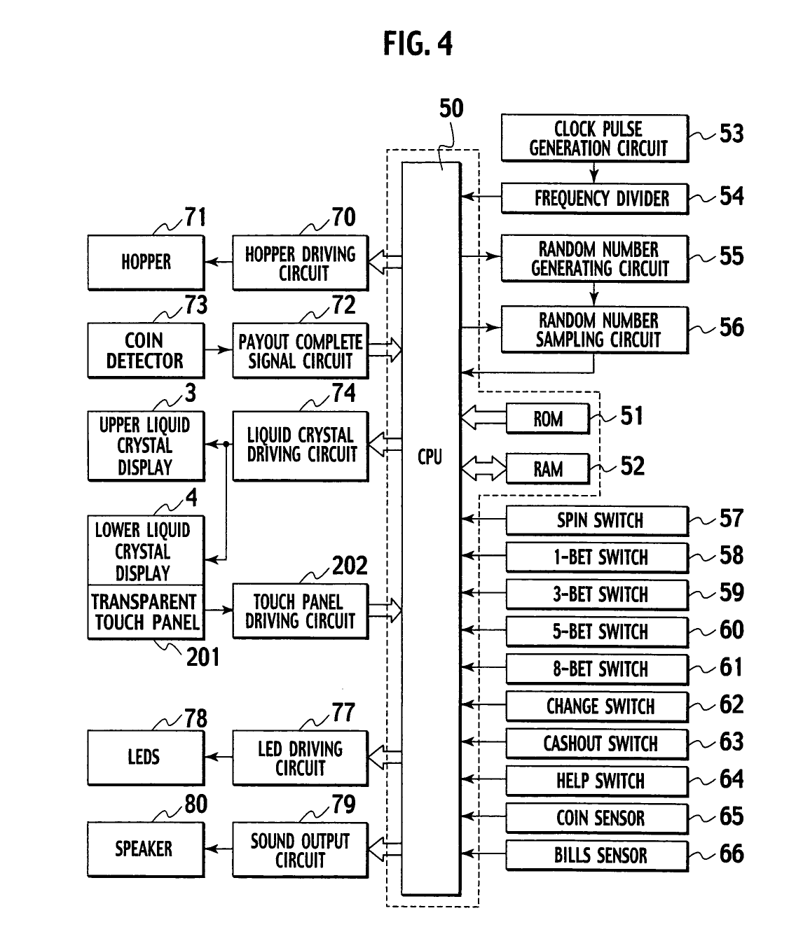

Next, a control system of the slot machine 1 will be described with reference to FIG. 4.

As shown in FIG. 4, the control system of the slot machine 1 comprises the upper liquid crystal display 3, the lower liquid crystal display 4, a CPU (central processing unit) 50, a ROM (read only memory) 51, a RAM (random access memory) 52, a clock pulse generating circuit 53, a frequency divider 54, a random number generating circuit 55, a random number sampling circuit 56,a spin switch 57, a 1-BET switch 58, a 3-BET switch 59, a 5-BET switch 60, an 8-BET switch 61, a change switch 62, a cashout switch 63, a help switch 64, the coin sensor 65, the bill sensor 66, a hopper driving circuit 70, a hopper 71, a payout complete signal circuit 72 a coin detector 73, a liquid crystal driving circuit 74, an LED (light emitting diode) driving circuit 77, a plurality of LEDs 78, a sound output circuit 79, a speaker 80,the transparent touch panel 201 and a touch panel driving circuit 202.

The ROM 51 and the RAM 52 are connected to the CPU 50. The ROM 51 stores a main process, a start reception process, a lottery process, a base game process, a lottery table to be employed to select symbols to be statically displayed in the game, and various programs and data tables to be employed to execute necessary processes in the slot machine 1 therein. The RAM 52 temporarily stores various data calculated by the CPU 50 therein.

In the exemplary embodiment, programs and data to be employed to control the slot machine 1 may be stored in a memory medium such as a compact flash (registered trademark). When the programs and data are employed in the slot machine 1, they are downloaded from the memory medium into the ROM 51 or the RAM 52.

The clock pulse generating circuit 53, the frequency divider 54, the random number generating circuit 55 and the random number sampling circuit 56 are connected to the CPU 50. The clock pulse generating circuit 53 generates a reference clock pulse. The random number generating circuit 55 generates a random number in series. Random numbers sampled by the random number sampling circuit 56 are employed at various lotteries such as a lottery for a winning combination. The spin switch 57, the 1-BET switch 58, the 3-BET switch 59, the 5-BET switch 60, the 8-BET switch 61, the change switch 62, the cashout switch 63, and the help switch 64 are connected to the CPU 50. The spin switch 57 is mounted to the spin/repeat BET button 12. The 1-BET switch 58 is mounted to the 1-BET button 11. The 3-BET switch 59 is mounted to the 3-BET button 13. The 5-BET switch 60 is mounted to the 5-BET button 14. The 8-BET switch 61 is mounted to the 8-BET button 15. The change switch 62 is mounted to the change button 6. The cashout switch 63 is mounted to the cashout button 7. The help switch 64 is mounted to the help button 8. The CPU 50 controls an operation corresponding to each button on the basis of a switch signal output from each switch by pushing the each button.

The coin sensor 65 and the bill sensor 66 are connected to the CPU 50. The coin sensor 65 detects a coin inserted into the coin insertion portion 9 and outputs a coin detecting signal into the CPU 50. The CPU 50 calculates the number of inserted coins on the basis of the coin detecting signal. The bill sensor 66 detects a type and amount of a bill inserted into the bill insertion portion 10 and outputs a bill detecting signal into the CPU 50. The CPU 50 calculates the number of coins corresponding to the amount of inserted bill on the basis of the bill detecting signal.

The hopper 71 is connected to the CPU 50 via the hopper driving circuit 70. If the CPU 50 outputs a driving signal into the hopper driving circuit 70, the hopper 71 pays out a certain number of coins from the coin payout opening 15. The coin detector 73 is connected to the CPU 50 via the payout complete signal circuit 72. The coin detector 73 is moutend in the coin payout opening 15. If the coin detector 73 detects that the certain number of coins is paid out from the coin payout opening 15, the coin detector 73 outputs a coin payout detecting signal into the payout complete signal circuit 72. The payout complete signal circuit 72 outputs a payout complete signal into the CPU 50 on the bias of the coin payout detecting signal.

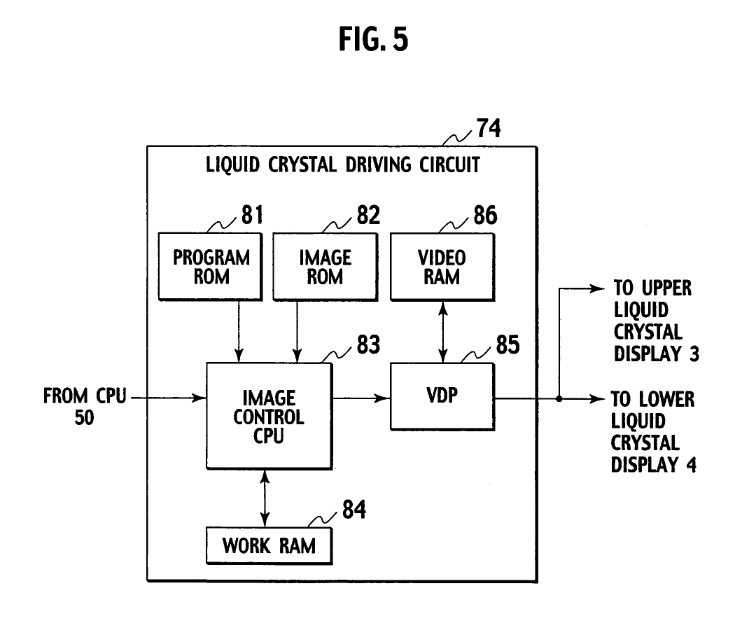

The upper liquid crystal display 3 and the lower liquid crystal display 4 are connected to the CPU 50 via the liquid crystal driving circuit 74 and controlled by the CPU 50. As shown in FIG. 5, the liquid crystal driving circuit 74 comprises a program ROM 81, an image ROM 82, an image control CPU 83, a work RAM 84, a VDP (video display processor) 85, and a video RAM 86.

The program ROM 81 stores therein an image control program and various select tables to be employed to display images on the upper liquid crystal display 3 and the lower liquid crystal display 4. The image ROM 82 stores therein dot data for forming images such as an effect image for a demonstration and various images for a treasure bonus to be displayed on the upper liquid crystal display 3 and the lower liquid crystal display 4, the help information and the payout table to be displayed on the upper liquid crystal display 3, and the various symbols of the video reel 100 to be displayed on the lower liquid crystal display 4. The image control CPU 83 selects an image to be displayed on the upper liquid crystal display 3 or the lower liquid crystal display 4 from among the dot data previously stored in the image ROM 82, according to the image control program previously stored in the program ROM 81, on the basis of a parameter determined by the CPU 50. The work RAM 84 temporarily stores the image control program therein when the image control CPU 83 executes the image control program. The VDP 85 generates image data corresponding to display contents determined by the image control CPU 83 and outputs the generated image data to the upper liquid crystal display 3 or the lower liquid crystal display 4. Thereby, as shown in FIG. 6, the various images of the video reel 100 are displayed on the variable display portion 22A to 22C, 23A to 23C, 24A to 24C of the lower liquid crystal display 4. The video RAM 86 temporarily stores the image data therein when the VDP 85 generates the image data.

The transparent touch panel 201 is connected to the CPU 50 via the touch panel driving circuit 202. The transparent touch panel 201 is mounted on a screen of the lower liquid crystal display 4 and outputs to the CPU 50 a coordinate position information including a position where a player touches the transparent touch panel 201. Thereby, the CPU 50 identifies the position where the player touches the transparent touch panel 201.

The LEDs 78 are connected to the CPU 50 via the LED driving circuit 77. The LEDs 78 are mounted on a front surface of the slot machine 1 and lighted by the LED driving circuit 77 on the basis of driving signals from the CPU 50 when the various effects are carried out. The speaker 80 is connected to the CPU 50 via the sound output circuit 79. The speaker 80 generates various effect sounds on the basis of output signals from the sound output circuit 79 when the various effects are carried out.

With reference to FIG. 6, the various symbols will be described below. As shown in FIG. 6, the symbols are a scatter 101, a sea turtle 102, a stonefish 103, a sea horse 104, a crab 105, a boxfish 106, an ammonite 107, a clownfish 108, a seal 109 and a spearfish 110. These symbols are variably displayed on each variable display portion from the right to the left of each variable display portion while the video reel 100 is rotated. The additional symbols to be displayed on the effect display regions 25A to 25I are the same symbols as the above symbols.

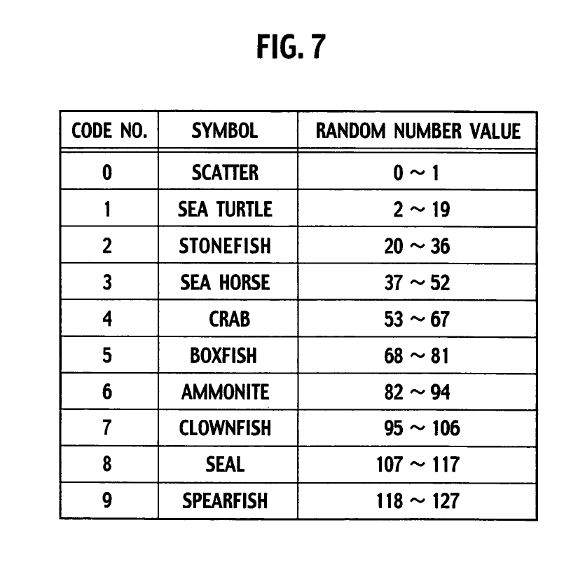

One symbol is statically displayed on each variable display portion on the basis of the lottery table shown in FIG. 7. The lottery table is stored in the ROM 51. Symbols to be statically displayed on the variable display portions 22A to 22C, 23A to 23C, 24A to 24C are determined every the variable display portions 22A to 22C, 23A to 23C, 24A to 24C. In the lottery table, code numbers “0”, “1”, “2”, “3”, “4”, “5”, “6”, “7”, “8” and “9” are respectively assigned to the scatter 101, the sea turtle 102, the stonefish 103, the sea horse 104, the crab 105, the boxfish 106, the ammonite 107, the clownfish 108, the seal 109 and the spearfish 110. Also, ranges of random numbers “0 to 1” , “2 to 19”, “20 to 36”, “37 to 52”, “53 to 67”, “68 to 81”, “82 to 94”, “95 to 106”, “107 to 117” and “118 to 127” are respectively assigned to the scatter 101, the sea turtle 102, the stonefish 103, the sea horse 104, the crab 105, the boxfish 106, the ammonite 107, the clownfish 108, the seal 109 and the spearfish 110. Nine random numbers corresponding to the variable display portions 22A to 22C, 23A to 23C, 24A to 24C are sampled through the random number sampling circuit 56.

If one random number corresponding to the variable display portion 23A is sampled and belongs within the range of random number “0 to 1”, the scatter 101 to which the code number “0” is assigned is statically displayed on the variable display portion 23A. If one random number corresponding to the variable display portion 23A is sampled and belongs within the range of random number “2 to 19”, the sea turtle to which the code number “1” is assigned is statically displayed on the variable display portion 23A. If one random number corresponding to the variable display portion 23A is sampled and belongs within the range of random number “20 to 36”, the stonefish 103 to which the code number “2” is assigned is statically displayed on the variable display portion 23A. If one random number corresponding to the variable display portion 23A is sampled and belongs within the range of random number “37 to 52”, the sea horse 104 to which the code number “3” is assigned is statically displayed on the variable display portion 23A. If one random number corresponding to the variable display portion 23A is sampled and belongs within the range of random number “53 to 67”, the carb 105 to which the code number “4” is assigned is statically displayed on the variable display portion 23A.

If one random number corresponding to the variable display portion 23A is sampled and belongs within the range of random number “68 to 81”, the boxfish 106 to which the code number “5” is assigned is statically displayed on the variable display portion 23A. If one random number corresponding to the variable display portion 23A is sampled and belongs within the range of random number “82 to 94”, the ammonite 107 to which the code number “6” is assigned is statically displayed on the variable display portion 23A. If one random number corresponding to the variable display portion 23A is sampled and belongs within the range of random number “95 to 106”, the clownfish 108 to which the code number “7” is assigned is statically displayed on the variable display portion 23A. If one random number corresponding to the variable display portion 23A is sampled and belongs within the range of random number “107 to 117”, the seal 109 to which the code number “8” is assigned is statically displayed on the variable display portion 23A. If one random number corresponding to the variable display portion 23A is sampled and belongs within the range of random number “118 to 127”, the spearfish 110 to which the code number “9” is assigned is statically displayed on the variable display portion 23A. The same symbol determination process is applied to the other variable display portions 22A to 22C, 23B to 23C, 24A to 24C.

Various winning combinations are previously determined in the ROM 51 (see FIG. 8). When a symbol combination identical to one of the winning combinations is statically displayed on each of the selected activated paylines, one or more coins are paid out from the coin payout opening 15 according to the stopped winning combination.

With reference to FIG. 8, the winning combinations and payouts for the winning combinations will be described below. The payout table 123 includes a payout sub-table 121 for ANY odds and a payout sub-table 122 for LINE odds and is stored in the ROM 51.

The payout sub-table 121 for ANY odds shows a payout to be given to a player with respect to each symbol, according to the number of same symbols statically displayed on all or a part of the variable display portions 22A to 22C, 23A to 23C, 24A to 24C which cross one or more activated paylines displayed on the lower liquid crystal display 4. For example, if the code numbers selected on five variable display portions on the activated paylines belong within the range “2 to 19”, “ANY 5 of the sea turtle 102” is won (see FIG. 7). In this case, the sea turtles 102 are statically displayed on the five variable display portions and a player can obtain a payout “1”. As described above, each payout for ANY odds is paid out according to the payout sub-table 121 for ANY odds shown in FIG. 8.

The payout sub-table 122 for LINE odds shows a payout per one line to be given to a player with respect to each symbol, according to the number of selected activated paylines each crossing all variable display portions on which the same symbols are statically displayed. For example, if the code numbers selected on all variable display portions on one activated payline belong within the range “2 to 19”, “sea turtle—sea turtle—sea turtle” is won (see FIG. 7). In this case, the sea turtles 102 are statically displayed on the all variable display portions and a player can obtain a payout “5”. It is noted that when there is a plurality of selected activated paylines each on which the “sea turtle—sea turtle—sea turtle” is won, a player can obtain a payout generated by multiplying the number of activated paylines by the payout “5”. As described above, each payout for LINE odds is paid out according to the payout sub-table 122 for LINE odds shown in FIG. 8.

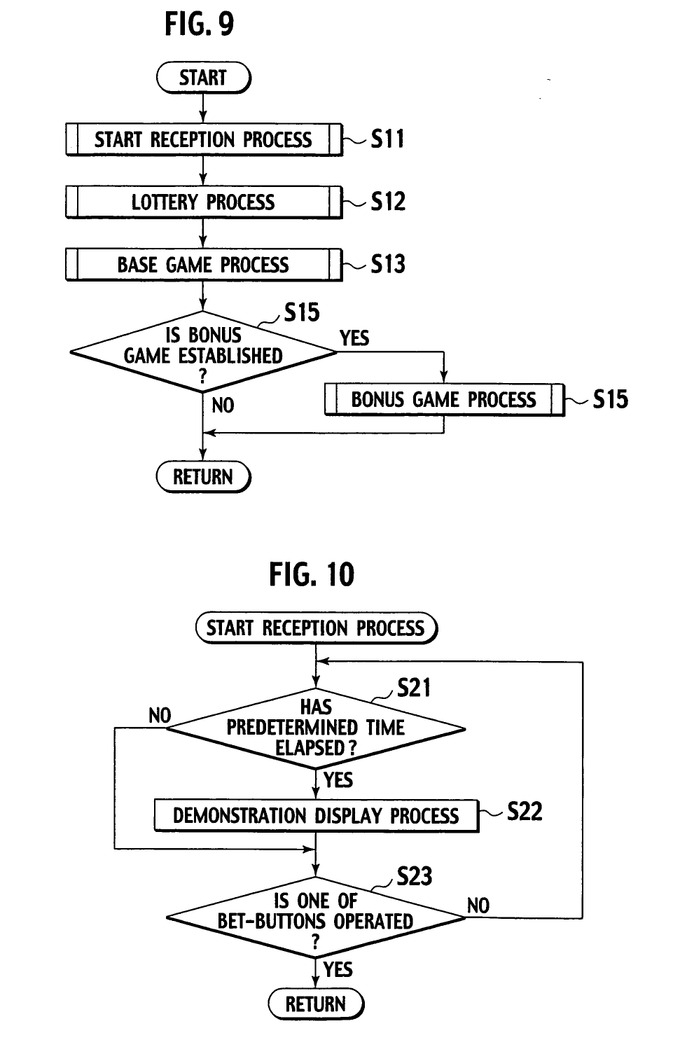

Next, with reference to FIGS. 9 to 16, operation of the slot machine 1 will be described below.

First, a main process of the slot machine 1 will be described below with reference to FIG. 9. In step S11, a start reception process is carried out after the slot machine 1 starts the main process. In the start reception process, the CPU 50 receives a switch signal output from the spin switch 57, the 1-BET switch 58, the 3-BET switch 59, the 5-BET switch 60 or the 8-BET switch 61 according to operation of the spin/repeat BET button 12, the 1-BET button 11, the 3-BET button 13, the 5-BET button 14, or the 8-BET button 15. When the CPU 50 receives the switch signal, the game is started.

More specifically, as shown in FIG. 10, in step S21, the CPU 50 determines whether or not a predetermined time (e.g. 15 seconds) has elapsed. If the predetermined time has not elapsed, the process proceeds to step S23. If the predetermined time has elapsed, the process proceeds to step S22. In step S22, the CPU 50 displays the effect image for the demonstration on the upper liquid crystal display 3 or the lower liquid crystal display 4. The display of the effect image is carried out according to an effect pattern previously determined.

In step S23, the CPU 50 determines whether or not the operation of the spin/repeat BET button 12, the 1-BET button 11, the 3-BET button 13, the 5-BET button 14, or the 8-BET button 15 is carried out. If the operation is not carried out, the process returns to step S21. If the operation is carried out, the CPU 50 interrupts the display of the effect image, and then displays one or more activated paylines according to the number of bet game media on the lower liquid crystal display 4 and the payout table 123 on the upper liquid crystal display 3. Then, the process proceeds to step S12.

In the exemplary embodiment, the activated paylines L1 to L8 are displayed on the lower liquid crystal display 4 according to the number of bet game media. However, all activated paylines L1 to L8 may be displayed on the lower liquid crystal display 4 on the basis of one bet game media and the amount of payout may be increased according to the number of bet game media.

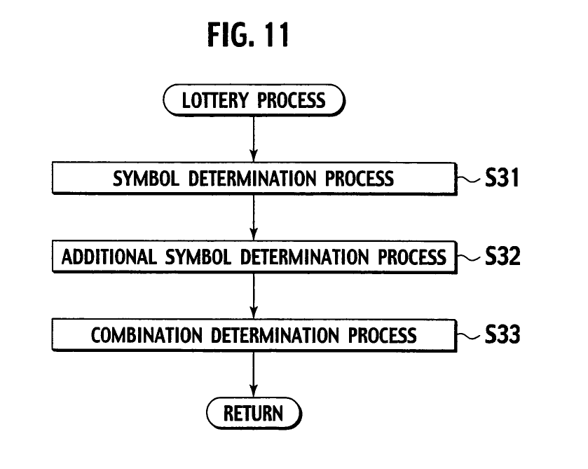

In step S12, a lottery process is carried out. More specifically, as shown in FIG. 11, in step S31, the CPU 50 carries out the symbol determination process. In the symbol determination process, the symbols to be statically displayed on the variable display portions 22A to 22C, 23A to 23C, 24A to 24C are determined every the variable display portions 22A to 22C, 23A to 23C, 24A to 24C. More specifically, nine random numbers corresponding to the variable display portions 22A to 22C, 23A to 23C, 24A to 24C are sampled within the ranges “0 to 127” through the random number sampling circuit 56, and the symbols to be statically displayed on the variable display portions 22A to 22C, 23A to 23C, 24A to 24C are determined though the code numbers on the basis of the lottery table.

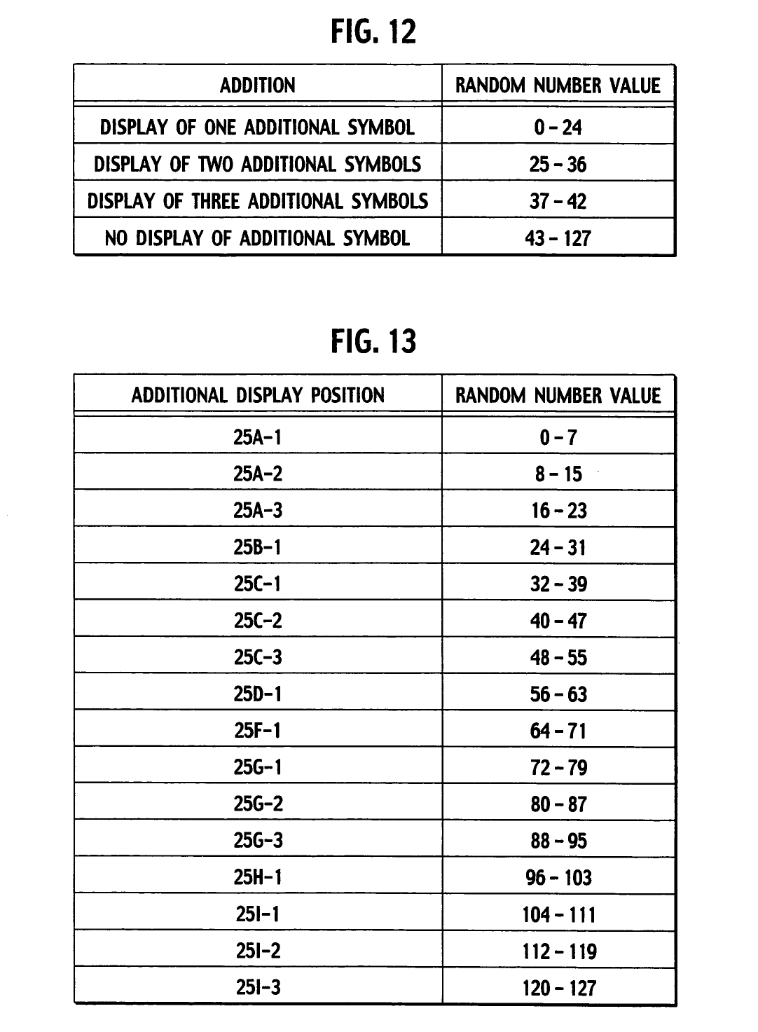

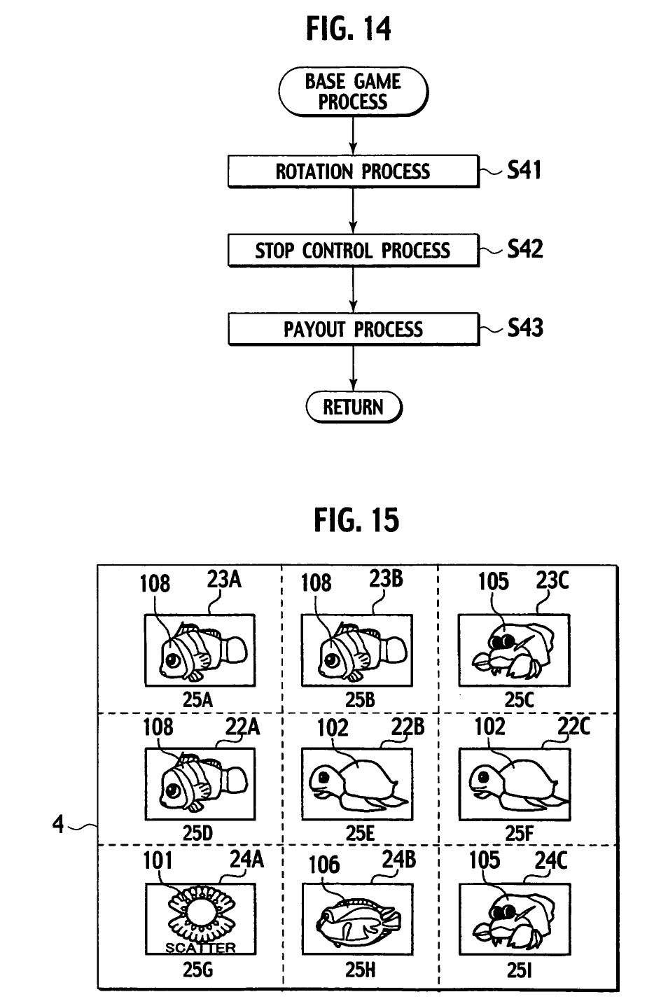

In step S32, the CPU 50 carries out an additional symbol determination process. In the additional symbol determination process, the CPU 50 determines the additional symbols to be displayed on the additional display positions 25A-1 to 25I-3 at a time of carrying out a stop control process in a base game process (see step S42 in FIG. 14). More specifically, the CPU 50 samples a random number value from among ranges of 0 to 127 by using the random number sampling circuit 56 and determines whether or not one or more additional symbols are displayed on the basis of a table shown in FIG. 12. If the one or more additional symbols are displayed, the CPU 50 determines the number of symbols to be additionally displayed according to the selected random number value. Then, the CPU 50 again samples a random number value from among ranges of 0 to 127 by using the random number sampling circuit 56 and determines one or more additional display positions on which the one or more additional symbols are displayed on the basis of a table shown in FIG. 13. In this case, a type of each additional symbol is determined through the code number on the basis of the lottery table like the symbol determination process.

With reference to the table shown in FIG. 12, when the random number value is equal to one of values 0 to 24, one additional symbol is displayed. When the random number value is equal to one of values 25 to 36, two additional symbols are displayed. When the random number value is equal to one of values 37 to 42, three additional symbols are displayed. When the random number value is equal to one of values 43 to 127, no additional symbol is displayed.

With reference to the table shown in FIG. 13, when the random number value is equal to one of values 0 to 7, one additional symbol is displayed on the additional display position 25A-1. When the random number value is equal to one of values 8 to 15, one additional symbol is displayed on the additional display position 25A-2. When the random number value is equal to one of values 16 to 23, one additional symbol is displayed on the additional display position 25A-3. When the random number value is equal to one of values 24 to 31, one additional symbol is displayed on the additional display position 25B-1. When the random number value is equal to one of values 32 to 39, one additional symbol is displayed on the additional display position 25C-1. When the random number value is equal to one of values 40 to 47, one additional symbol is displayed on the additional display position 25C-2. When the random number value is equal to one of values 48 to 55, one additional symbol is displayed on the additional display position 25C-3. When the random number value is equal to one of values 56 to 63, one additional symbol is displayed on the additional display position 25D-1.

When the random number value is equal to one of values 64 to 71, one additional symbol is displayed on the additional display position 25F-1. When the random number value is equal to one of values 72 to 79, one additional symbol is displayed on the additional display position 25G-1. When the random number value is equal to one of values 80 to 87, one additional symbol is displayed on the additional display position 25G-2. When the random number value is equal to one of values 88 to 95, one additional symbol is displayed on the additional display position 25G-3. When the random number value is equal to one of values 96 to 103, one additional symbol is displayed on the additional display position 25H-1. When the random number value is equal to one of values 104 to 111, one additional symbol is displayed on the additional display position 25I-1. When the random number value is equal to one of values 112 to 119, one additional symbol is displayed on the additional display position 25I-2. When the random number value is equal to one of values 120 to 127, one additional symbol is displayed on the additional display position 25I-3.

If the number of additional symbols is equal to two or three, the CPU 50 repeats sampling a random number value from among ranges of 0 to 127 by using the random number sampling circuit 56 two or three times. It is noted that the additional display positions do not overlap each other.

In step S33, the CPU 50 carries out a combination determination process. In the combination determination process, the CPU 50 determines the type of winning combination on each activated payline displayed on the lower liquid crystal display 4 and the payout for the winning combination, on the basis of the payout table 123 stored in the ROM 51. It is noted that the additional display positions 25A-1 to 25I-3 are arranged on the activated payline L1 to L8. Therefore, one or more game media are paid out when symbols displayed on the variable display portions or symbols and one or more additional symbols displayed on the variable display portions and one or more additional display positions constitute one of the winning combinations shown in the payout table 123. Then, the process proceeds to step S13.

In step S13, the base game process is carried out. More specifically, as shown in FIG. 14, in step S41, the CPU 50 carries out a rotation process. In the rotation process, the various symbols shown in FIG. 6 are variably displayed on each variable display portion from the right to the left of each variable display portion while the video reel 100 rotates. It is noted that, in the rotation process, the various additional symbols are variably displayed on each additional display position while the video reel 100 rotates.

In step S42, the CPU 50 carries out the stop control process. In the stop control process, one symbol is statically displayed on each variable display portion on the basis of the lottery result in the symbol determination process (step S31). It is noted that, in the stop control process, one additional symbol is statically displayed on each additional display position on the basis of the lottery result in the additional symbol determination process (step S32).

In step S43, the CPU 50 carries out a payout process. In the payout process, the CPU 50 pays out one or more game media corresponding to a payout previously determined in the payout table 123 according to the symbols on each activated payline. If a plurality of winning combinations is established on a plurality of activated paylines, the CPU 50 adds up the payouts for the plurality of winning combinations. Then, the process proceeds to step S14.

In step S14, the CPU 50 determines whether or not a bonus game is established according to the symbols statically displayed on each activated payline in the stop control process (step S42), or the random number or combination determined in the lottery process (step S12).

If the bonus game is established, the process proceeds to step S15. In step S15, the CPU 50 carries out a bonus game process. In the bonus game process, the CPU 50 executes a free game in which free spins are played predetermined times (e.g. ten times). In the free game, the CPU 50 carries out the base game process without consuming any game media or accumulated credits. Therefore, a player can play the free game without inserting any coins or pushing any bet buttons. As a result, in the bonus game, it is possible for the player to obtain one or more game media without consuming any game media or accumulated credits. It is noted that the bonus game is not limited to the free game and may be another game. Then, the process is finished. If the bonus game is not established, the process is finished.

Next, with reference to FIG. 15, 16, two examples of image displays on the lower liquid crystal display 4 during the base game will be described below.

In one example of an image display shown in FIG. 15, two clownfishes 108 are statically displayed on the variable display portions 23A, 23B and one crab 105 is statically displayed on the variable display portion 23C, on the basis of the lottery result in the symbol determination process (step S31 in FIG. 11). One clownfish 108 is statically displayed on the variable display portion 22A and two sea turtles 102 are statically displayed on the variable display portions 22B, 22C, on the basis of the lottery result in the symbol determination process. One scatter 101, one boxfish 106 and one carb 105 are displayed on the variable display portions 24A, 24B, 24C, respectively, on the basis of the lottery result in the symbol determination process. Therefore, as shown in FIGS. 3, 15, two clownfishes 108 are statically displayed on the activated payline L2 abreast with each other. Also, two clownfishes 108 are statically displayed on the activated payline L6 tandem with each other. Further, two sea turtles 102 are statically displayed on the activated payline L1 abreast with each other.

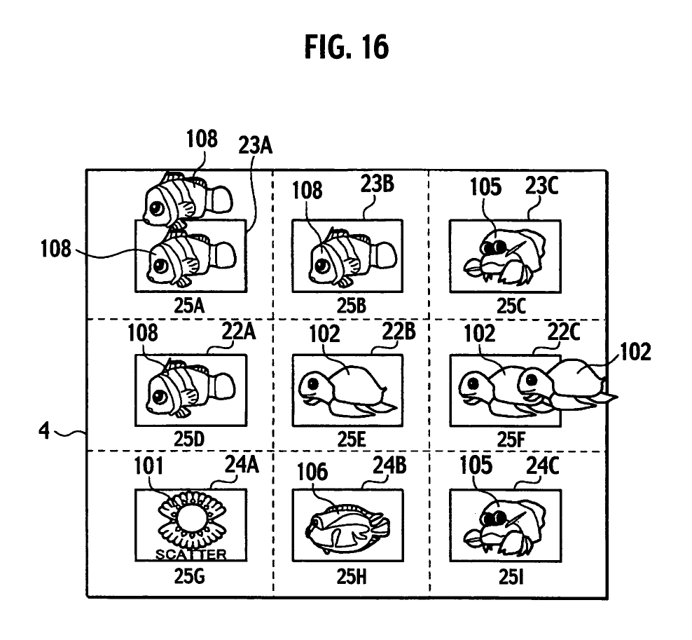

In another example of an image display shown in FIG. 16, one clownfish 108 and one sea turtle 102 are additionally displayed on the additional display positions 25A-3, 25F-1 on the basis of the lottery result in the additional symbol determination process (step S32 in FIG. 11), in addition to the displayed symbols shown in FIG. 15. Therefore, as shown in FIGS. 3, 16, three clownfishes 108 are statically displayed on the activated payline L6 tandem with one another. Also, three sea turtles 102 are statically displayed on the activated payline L1 abreast with one another.

Thus, in the slot machine 1, one or more symbols are additionally displayed on one or more additional display positions on the basis of the lottery result in the additional symbol determination process. In the another example of the image display shown in FIG. 16, a player wins “sea turtle-sea turtle-sea turtle” on the activated payline L1 and “clownfish-clownfish-clownfish” on the activated payline L6. Through the additional symbol determination process, as shown in FIG. 8, the player can obtain the payout “55 (=50+5)” in the base game. If there is not the additional symbol determination process, the player can not obtain any payout on the basis of the lottery result in the symbol determination process.

The advantageous features of the slot machine 1 will be described below.

Opportunity for obtaining a payout increases in comparison with the conventional slot machine because one or more additional symbols may be additionally displayed on one or more additional display positions on the basis of the lottery result in the additional symbol determination process. Therefore, the slot machine 1 can increase player's sense of expectancy and attract player's interest.

Even if a player is accustomed to play at the slot machine 1, the player can play at the slot machine 1 without getting tired because one or more additional symbols may be additionally displayed on one or more additional display positions on the basis of the lottery result in the additional symbol determination process.

Especially, the additional symbols are additionally displayed on the additional display positions 25A-1 to 25I-3 which is located in the vicinity of the variable display portions 22A to 22C, 23A to 23C, 24A to 24C and on the actibated paylines L1 to L8. Thus, since the additional symbols which are used as symbols for a winning determination are displayed on the activated paylines L1 to L8, even if no winning combination is established on the activated paylines L1 to L8 by symbols only displayed on the variable display portions 22A to 22C, 23A to 23C, 24A to 24C, it is possible to establish one or more winning combinations on the activated paylines L1 to L8 by symbols displayed on the variable display portions 22A to 22C, 23A to 23C, 24A to 24C and the additional display positions 25A-1 to 25I-3.

Further, the symbols are variably displayed on the variable display portions 22A to 22C, 23A to 23C, 24A to 24C in a certain direction and the additional symbols are variably displayed on the additional display positions 25A-1 to 25I-3 independent of the certain direction, while the video reels 100 rotates. Thus, since the additional symbols are variably displayed on the additional display positions 25A to 25I independent of a variable direction of symbols on the variable display portions 22A to 22C, 23A to 23C, 24Ato 24C, the slot machine 1 can provide various variable display patterns for a player to attract player's interest.

The present invention is not limited to the above-described exemplary embodiment and may be embodied in other specific forms without departing from the idea thereof. Various modification of the present invention will be described below.

A new additional display position may be mounted between adjacent two variable display portions (e.g. between the variable display portions 23A and 22A or between the variable display portions 23A and 22B).

A new activated payline may be mounted on the lower liquid crystal display 4 other than the activated paylines L1 to L8. In this case, the new additional display position may be mounted on the new activated payline.

The slot machine 1 may additionally display one or more additional symbols on the basis of the lottery result of the additional symbol determination process in a game (e.g. a bonus game or both of the base game and the bonus game) other than the base game.

Only if a certain condition (e.g. certain symbols are statically displayed at the amount equal to or more than a certain value) is met in the symbol determination process (step S31), the lottery results of the symbol determination process and the additional symbol determination process (step S32) may be included in the combination determination process (step S33). On the other hand, if the certain condition is not met in the symbol determination process, the lottery result of the symbol determination process may be only included in the combination determination process. Thus, the slot machine 1 may determine whether or not the lottery result of the additional symbol determination process is included in the combination determination process according to the certain condition. Therefore, since one or more additional symbols are statically displayed on one or more activated paylines only if the certain condition is met, the slot machine 1 allows a player to further attach his/her mind to the game.

When a player wins one or more game media, the player may receive a magnet card in which the amount of game media to be paid out may be recorded or a receipt in which the amount of game media to be paid out may be printed. Further, the amount of game media to be paid out may be managed in a server that manages plural pieces of information regarding the slot machine 1.

Contents of lotteries in the lottery process are not limited to using the lottery tables each corresponding to the random number values and the symbols and may be adequately modified.

What is claimed is:

1. A gaming machine comprising:
a display that includes therein a symbol display region in which a plurality of symbols to be used in a game are variably displayed and an effect display region in which effect contents are displayed according to a game state; and
a controller that controls the variable display of symbols in the symbols display region and the effect contents in the effect display region,
wherein the controller displays one or more symbols to be used for a winning determination in the game, in the effect display region and in the vicinity of one or more symbols displayed in the symbol display region.

2. The gaming machine according to claim 1, wherein the controller displays the one or more symbols to be used for the winning determination in the game, on one or more activated paylines previously set in the display.

3. The gaming machine according to claim 1, wherein the controller variably displays the plurality of symbols in the symbol display region in a certain direction and variably displays the one ore more symbols to be used for the winning determination in the game without relation to the certain direction.

4. The gaming machine according to claim 1, wherein the controller carries out the winning determination on the basis of a combination of any one of more symbols displayed in the symbol display region and any one or more symbols displayed in the effect display region when a certain condition is met.

5. The gaming machine according to claim 4, wherein the controller carries out the winning determination when one or more certain symbols are displayed in the symbol display region.
